(19) United States
(12) Patent Application Publication
(10) Pub. No.: US 2015/0161283 A1
(43) Pub. Date: Jun. 11, 2015

(54) MOBILE TERMINAL AND CONTROLLING METHOD THEREOF

(71) Applicant: LG ELECTRONICS INC., Seoul (KR)

(72) Inventor: Jechan HAN, Seoul (KR)

(73) Assignee: LG ELECTRONICS INC.

(21) Appl. No.: 14/557,518

(22) Filed: Dec. 2, 2014

(30) Foreign Application Priority Data
Dec. 5, 2013 (KR) 10-2013-0150610

(51) Int. Cl. G06F 17/30; G06F 3/0482; G06F 3/0481; H04M 1/725; G06F 3/0484

(52) U.S. Cl. CPC G06F 17/30887; H04M 1/72561; G06F 17/30784; G06F 3/04842; G06F 3/04817; G06F 3/0482

(57) ABSTRACT

A mobile terminal and controlling method thereof are disclosed, by which a video on a webpage can be watched conveniently and easily. The present disclosure includes a wireless communication unit configured to access a webpage including a video, a touchscreen configured to display the webpage, and a controller extracting an address information of the video from the webpage, and the controller configured to extract address information of the video from the webpage, create an execution file for the video to which the extracted address information is linked, and if an execution command for the execution file is inputted, control the video indicated by the address information to be played by streaming.

### CROSS-REFERENCE TO RELATED APPLICATION

Pursuant to 35 U.S.C. §119(a), this application claims the benefit of earlier filing date and right of priority to Korean Application No. 10-2013-0150610, filed on Dec. 5, 2013 the contents of which are hereby incorporated by reference herein in its entirety.

### BACKGROUND OF THE INVENTION

1. Field of the Invention

The present disclosure relates to a mobile terminal, and more particularly, to a mobile terminal and controlling method thereof. Although the present disclosure is suitable for a wide scope of applications, it is particularly suitable for watching a video on a webpage conveniently and easily.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

Thus, a user can create and watch a content by performing a photographing or recording directly using a mobile terminal. And, the user is able to watch a web content by downloading the web content from a webpage on which contents are posted through the Internet.

Yet, in case of the web contents on the webpage, a user may often have difficulty in downloading the web contents. For instance, if a video is posted on a webpage or a poster or copyrighter restricts a download of a video, a user is unable to download the video.

In this case, the user cannot help running the corresponding video on the webpage by accessing the corresponding webpage on the Internet. In order to watch the video again, complicated steps of running a web browser, searching for the video, outputting a webpage containing the video, playing the video on the webpage and the like are required. Although the user can skip the video searching step by bookmarking the webpage, the user still needs to perform the web browser running step and the webpage selecting step on a bookmark list.

In particular, in order for a user to watch a non-downloadable video, which is not saved in a mobile terminal, on a webpage, it is inconvenient for the user to perform the complicated steps.

Moreover, a video saved in a mobile terminal should be watched through an app for a video play and a video failing to be saved in a mobile terminal should be watched through a webpage. Hence, inconvenience is caused to user experience.

In order to enhance the utilization of a mobile terminal, a multitude of developers make ongoing efforts to research and develop applications runnable in the mobile terminal. As a result of the efforts, there may exist a multitude of applications capable of performing the same function. Hence, a user is able to conveniently install and utilize an application appropriate for user's taste. If a plurality of applications capable of performing the same function are installed on a mobile terminal, a user may be able to run an application appropriate for user's taste from moment to moment. For instance, in case that a multitude of applications for watching a photo file are installed, a user may be able to watch the photo file through a desired application in consideration of UI convenience and utilization for each of the applications.

However, if numerous applications are installed on a mobile terminal, a user may have difficulty in searching the numerous applications for a desired application.

### SUMMARY OF THE INVENTION

Accordingly, embodiments of the present disclosure are directed to a mobile terminal and controlling method thereof that substantially obviate one or more problems due to limitations and disadvantages of the related art.

An object of the present disclosure is to provide a mobile terminal and controlling method thereof, which enables a user to conveniently watch a video failing to be saved in the mobile terminal.

In particular, one object of the present disclosure is to provide a mobile terminal and controlling method thereof, which enables a user to watch a video posted on a webpage without being saved in the mobile terminal through the same user interface for a video saved in the mobile terminal in watching a video.

Another object of the present disclosure is to provide a mobile terminal and controlling method thereof, by which an execution file capable of playing a video can be created by accessing a video displayed webpage without directly downloading the video on the webpage.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal according to one embodiment of the present disclosure may include a wireless communication unit configured to access a webpage including a video, a touchscreen configured to display the webpage, and a controller configured to extract address information of the video from the webpage, create an execution file for the video to which the extracted address information is linked, and if an execution command for the execution file is inputted, control the video indicated by the address information to be played by streaming.

In another aspect of the present disclosure, a method of controlling a mobile terminal according to one embodiment of the present disclosure may include displaying a webpage including a video, extracting address information of the video from the webpage, creating an execution file for the video to which the extracted address information is linked, and if an execution command for the execution file is inputted, playing the video indicated by the address information by streaming.

Effects obtainable from the present disclosure may be non-limited by the above mentioned effect. And, other unmentioned effects can be clearly understood from the following description by those having ordinary skill in the technical field to which the present disclosure pertains.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present disclosure will become more apparent upon consideration of the following description of preferred embodiments, taken in conjunction with the accompanying drawing figures. In the drawings:

FIG. 1 is a block diagram of a mobile terminal according to one embodiment of the present disclosure;

FIG. 2 is a front perspective diagram of a mobile terminal according to one embodiment of the present disclosure;

FIG. 3 is a rear perspective diagram of a mobile terminal according to one embodiment of the present disclosure;

FIG. 4 is a diagram for one example to describe a content according to an embodiment of the present disclosure;

FIG. 5 is a flowchart for an operation of a mobile terminal according to an embodiment of the present disclosure;

FIG. 6 is a diagram for one example to describe an execution file according to an embodiment of the present disclosure;

FIG. 7 is a diagram for one example to describe a creation interface of an execution file according to an embodiment of the present disclosure;

FIG. 8 is a diagram for one example to describe a video list according to an embodiment of the present disclosure;

FIG. 9 is a diagram for one example to describe an execution scene of an execution file according to an embodiment of the present disclosure;

FIG. 10 us a flowchart to describe a process for creating a thumbnail image according to an embodiment of the present disclosure;

FIG. 11 is a diagram for one example to describe a type of a thumbnail image according to an embodiment of the present disclosure;

FIG. 12 is a diagram for one example to describe an operation of a mobile terminal 100 in case of failure in playing a video according to an embodiment of the present disclosure;

FIG. 13 is a diagram for one example to describe a process for restoring an execution file according to an embodiment of the present disclosure; and

FIG. 14 is a diagram for one example to describe a screen displayed in case of failing in executing an execution file according to an embodiment of the present disclosure.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present disclosure. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present disclosure can be applicable to a various types of mobile terminals. Examples of such terminals include mobile phones, user equipments, smart phones, digital broadcast receivers, personal digital assistants, laptop computers, portable multimedia players (PMP), navigators and the like.

Yet, it is apparent to those skilled in the art that a configuration according to an embodiment disclosed in this specification is applicable to such a fixed terminal as a digital TV, a desktop computer and the like as well as a mobile terminal.

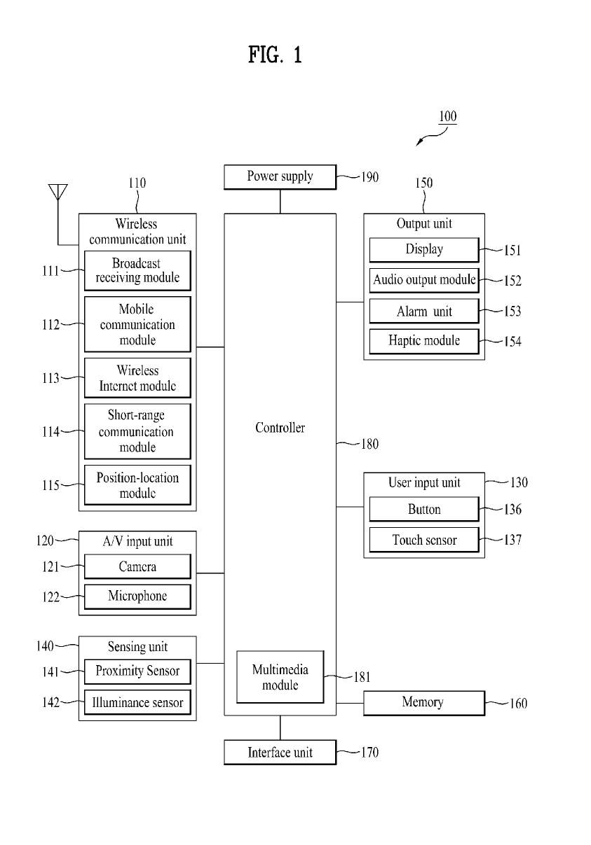

FIG. 1 is a block diagram of a mobile terminal 100 in accordance with an embodiment of the present disclosure. FIG. 1 shows the mobile terminal 100 according to one embodiment of the present disclosure includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel. The broadcast channel may include a satellite channel and a terrestrial channel. At least two broadcast receiving modules 111 can be provided to the mobile terminal 100 in pursuit of simultaneous receptions of at least two broadcast channels or broadcast channel switching facilitation.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), Convergence of Broadcasting and Mobile Service (DVB-CBMS), Open Mobile Alliance-BroadCAST (OMA-BCAST), China Multimedia Mobile Broadcasting (CMMB), Mobile Broadcasting Business Management System (MBBMS), the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module. According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a button 136 provided to front/rear/lateral side of the mobile terminal 100 and a touch sensor (constant pressure/electrostatic) 137 and may further include a key pad, a dome switch, a jog wheel, a jog switch and the like [not shown in the drawing].

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. By nonlimiting example, such sensing unit 140 include, gyro sensor, accelerate sensor, geomagnetic sensor.

As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, and a haptic module 154 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and the touch sensor 137 configures a mutual layer structure (hereinafter called ‘touch screen’), it is able to use the display 151 as an input device as well as an output device. In this case, the touch sensor can be configured as a touch film, a touch sheet, a touchpad or the like.

The touch sensor 137 can be configured to convert a pressure applied to a specific portion of the display 151 or a variation of a capacitance generated from a specific portion of the display 151 to an electric input signal. Moreover, it is able to configure the touch sensor 137 to detect a pressure of a touch as well as a touched position or size.

If a touch input is made to the touch sensor 137, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

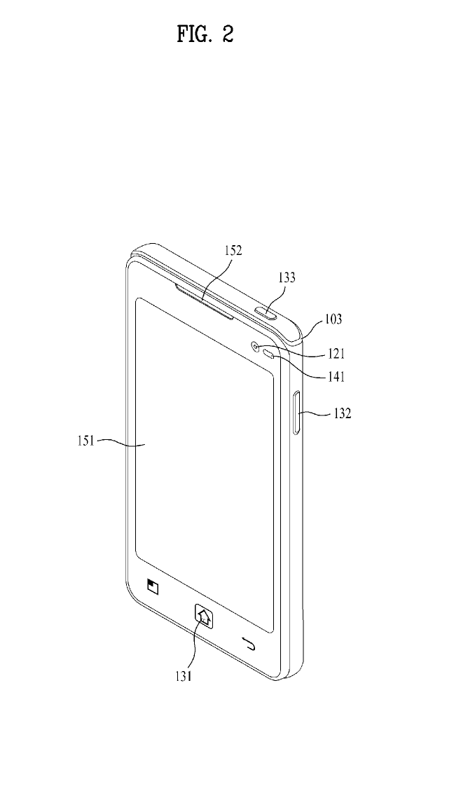

Referring to FIG. 2, a proximity sensor (141) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

For clarity and convenience of the following description, as a pointer becomes proximate to a touchscreen without coming into contact with the touchscreen, if the pointer is perceived as situated over the touchscreen, such an action shall be named ‘proximity touch’. If a pointer actually comes into contact with a touchscreen, such an action shall be named ‘contact touch’. A proximity-touched position over the touchscreen with the pointer may mean a position at which the pointer vertically opposes the touchscreen when the touchscreen is proximity-touched with the pointer.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectable to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

A battery may include a built-in rechargeable battery and may be detachably attached to the terminal body for a charging and the like. A connecting port may be configured as one example of the interface 170 via which an external charger for supplying a power of a battery charging is electrically connected.

Various embodiments described herein may be implemented in a computer-readable medium using, for example, computer software, hardware, or some combination thereof.

For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

FIG. 2 is a front perspective diagram of a mobile terminal according to one embodiment of the present disclosure.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2A, the mobile terminal 100 includes a case (101, 102, 103) configuring an exterior thereof. In the present embodiment, the case can be divided into a front case 101 and a rear case 102. Various electric/electronic parts are loaded in a space provided between the front and rear cases 101 and 102.

Occasionally, electronic components can be mounted on a surface of the rear case 102. The electronic part mounted on the surface of the rear case 102 may include such a detachable part as a battery, a USIM card, a memory card and the like. In doing so, the rear case 102 may further include a backside cover 103 configured to cover the surface of the rear case 102. In particular, the backside cover 103 has a detachable configuration for user's convenience. If the backside cover 103 is detached from the rear case 102, the surface of the rear case 102 is exposed.

Referring to FIG. 2, if the backside cover 103 is attached to the rear case 102, a lateral side of the rear case 102 may be exposed in part. If a size of the backside cover 103 is decreased, a rear side of the rear case 102 may be exposed in part. If the backside cover 103 covers the whole rear side of the rear case 102, it may include an opening 103′ configured to expose a camera 121′ or an audio output unit 152′ externally.

The cases 101, 102 and 103 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the case 101 or 102.

The display 151 occupies most of a main face of the front case 101. The audio output unit 152 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152 and the like can be inputted to the second manipulating unit 132, a command for a switching to a touch recognizing mode of the display 151 and the like can be inputted to the second manipulating unit 133.

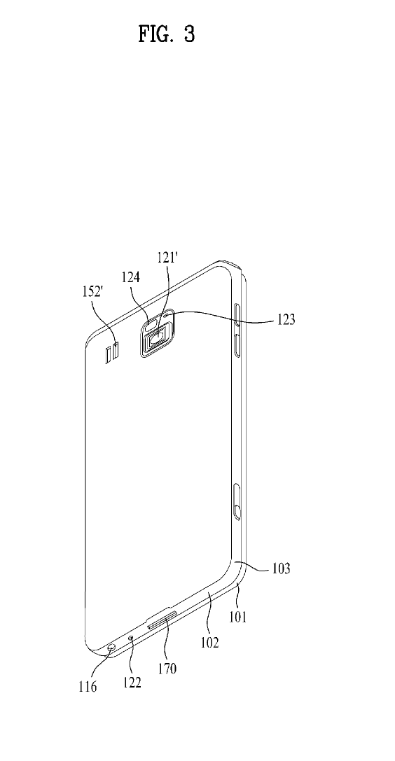

FIG. 3 is a perspective diagram of a backside of the terminal shown in FIG. 2.

Referring to FIG. 3, a camera 121′ can be additionally provided to a backside of the terminal body, and more particularly, to the rear case 102. The camera 121 has a photographing direction that is substantially opposite to that of the former camera 121 shown in FIG. 2 and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2 and may be used for implementation of a speakerphone mode in talking over the terminal.

A broadcast signal receiving antenna 116 can be additionally provided to the lateral side of the terminal body as well as an antenna for communication or the like. The antenna 116 constructing a portion of the broadcast receiving module 111 shown in FIG. 1 can be retractably provided to the terminal body.

For clarity and convenience of the following description, assume that a mobile terminal mentioned in the following description includes at least one of the components shown in FIG. 1. In particular, assume that a mobile terminal according to the present disclosure may include the display unit 151, the memory 160 and the controller 180. In some cases, assume that the mobile terminal 100 according to the present disclosure may further include the proximity sensor 141. The display unit 151 of the mobile terminal 100 mentioned in the description of the present disclosure can be implemented with a touchscreen 151. If the display module or unit 151 includes the touchscreen 151, implementation of the present disclosure can be further facilitated. Therefore, the following description is made on the assumption that the display module or unit 151 includes the touchscreen 151. Moreover, if the user input unit 130 is configured with the touch sensor 137, the touchscreen 151 may be used as the user input unit 130.

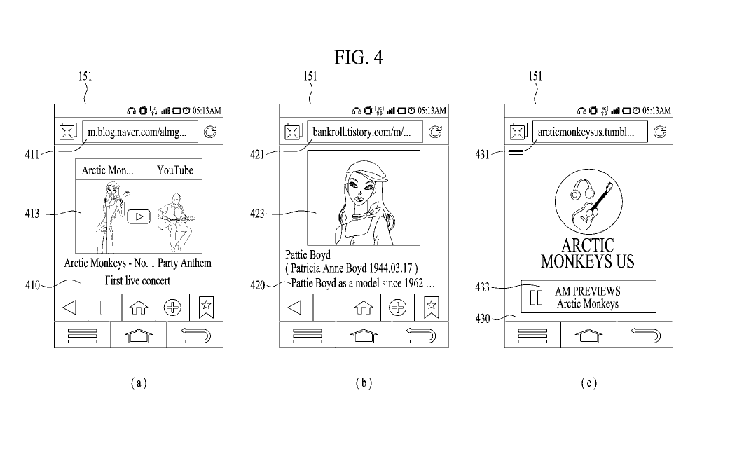

FIG. 4 is a diagram for one example to describe a content according to an embodiment of the present disclosure.

Referring to FIG. 4, according to the present disclosure, a content may mean at least one of a text, an image, a video, an audio data and a multimedia data created from a combination thereof. If a user searches for a specific content through a web browser using the mobile terminal 100 and then selects a specific webpage, the controller 180 can control a webpage, which is shown in one of FIGS. 4 (a) to 4 (c), to be displayed.

Referring to FIG. 4 (a), as one example of a content, a video 413 posted on a webpage 410 is illustrated. The webpage 410 has an address 411 and includes the video 413. Referring to FIG. 4 (b), as one example of a content, an image 423 posted on a webpage 420 is illustrated. The webpage 420 has an address 421 and includes the image 423. Referring to FIG. 4 (c), as one example of a content, a music clip 433 posted on a webpage 430 is illustrated. The webpage 430 has an address 431 and includes the music clip 433.

According to the present disclosure, an execution file is a file for the above-mentioned various contents and may mean that the controller 180 can recognize a type of a content and a program for executing the corresponding content. Particularly, in the present specification, as shown in FIG. 4 (a), a case that an execution file is a video content is described for example.

An execution file of the present disclosure may have a separate extension name. For instance, a name such as dawv (direct access to web video clip) is applicable.

In case that the execution file relates to a video content, the controller 180 can recognize an execution file having a specific extension name as a video content. Hence, if the execution file is created, the controller 180 can control the execution file to be saved in the same region of an existing video file. In the present specification, the existing video file may include a video file externally downloaded in advance through the wireless communication unit 110 or a video file created by a user from taking a video through the camera 121 of the mobile terminal 100.

The controller 180 registers the extension name of the execution file at a program for managing videos of the mobile terminal 180, thereby controlling the execution file to be handled in the same manner of the existing video file in various modules and programs of the mobile terminal 100.

In particular, since the execution file is recognized as a video file in the mobile terminal 100, the controller 180 can control the created execution file to be displayed on the video list together with the existing video file.

Moreover, in case that a user intends to play a video by selecting the execution file, the controller 180 can control a user interface, which is used for the same process of selecting and playing the existing video file, to apply to the execution file. And, the same operation as an editing operation (e.g., ‘move’, ‘copy’, ‘delete’, etc.) on the existing video file may be performed on the execution file by the controller 180 in response to a user input.

Moreover, as the execution file is shared with a different mobile terminal or posted on a webpage, a different user can use the execution file in the same manner as used by the mobile terminal 100 according to the present disclosure on the web or through the different user's mobile terminal.

In case that a separate program or app capable of recognizing and executing the execution file is saved in the controller 180 or the memory 160 of the mobile terminal 100, the controller 180 can control a video to be played by recognizing the execution file through the saved separate program or app.

If the separate program or app is not present, the controller 180 accesses an address of a video included in the execution file through the wireless communication unit 110 and may be then able to control a video content for the execution file to be played on the web.

The execution file may be saved in at least one of the memory 160 and the controller 180 of the mobile terminal 100.

According to the present disclosure, a user interface for registration, execution and restoration of the execution file and the like is operable by receiving an input of a touch gesture from a user. In this case, the touch gesture means an input action for manipulating the mobile terminal 100 through the touchscreen 151. The controller 180 can recognize the user's touch gesture inputted through the touchscreen 151 as a manipulation command for manipulating the mobile terminal 100. Types of the touch gesture may include a user's tapping action on a specific point of the touchscreen 151, a flicking action, a touch drag action of drawing a specific trace and the like. Moreover, as mentioned in the foregoing description, if the mobile terminal 100 includes the proximity sensor 141, the touch gesture may include a proximity touch.

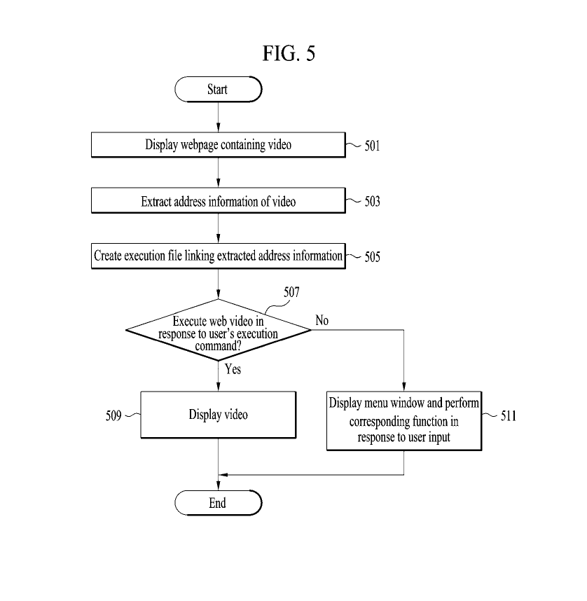

Embodiments of the present disclosure are described in detail with reference to FIGS. 5 to 10 as follows.

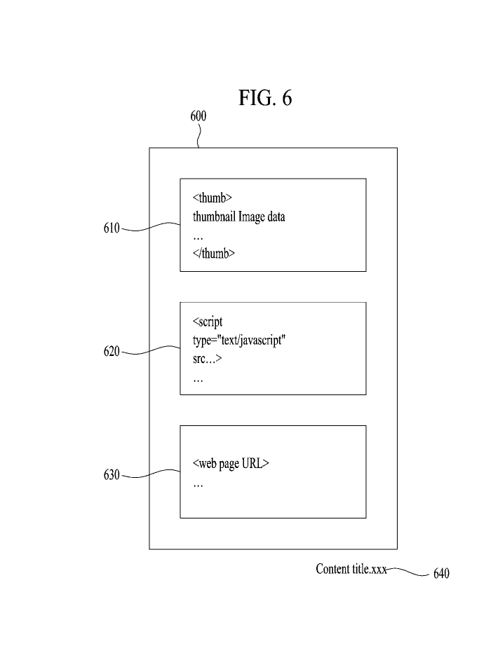

FIG. 5 is a flowchart for an operation of a mobile terminal according to an embodiment of the present disclosure. And, FIG. 6 is a diagram for one example to describe an execution file according to an embodiment of the present disclosure.

Referring to FIG. 5, as mentioned in the foregoing description with reference to FIG. 4 (a), the controller 180 can control the webpage 410 including the video 413 to be displayed [S501].

The controller 180 can determine whether the video 413 is included in the displayed webpage 410. As a result of the determination, if the video 413 is detected as posted on the webpage 410, the controller 180 can extract an address information of the video 413 through the webpage 401 [S503]. In this case, the address information may include an information of URL format for a video or an information of Java script command format.

Once the address information is extracted, the controller 180 can control an execution file, to which the address information is linked, to be created [S505]. Once the execution file is created, the controller 180 can control the execution file to be saved in the same region in which other existing videos are saved.

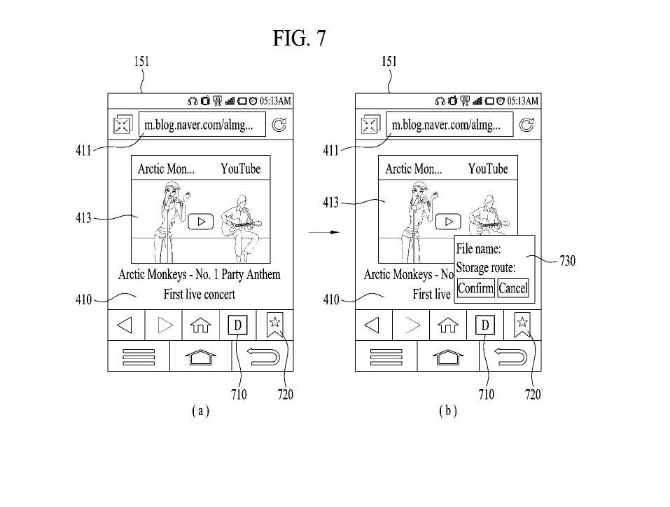

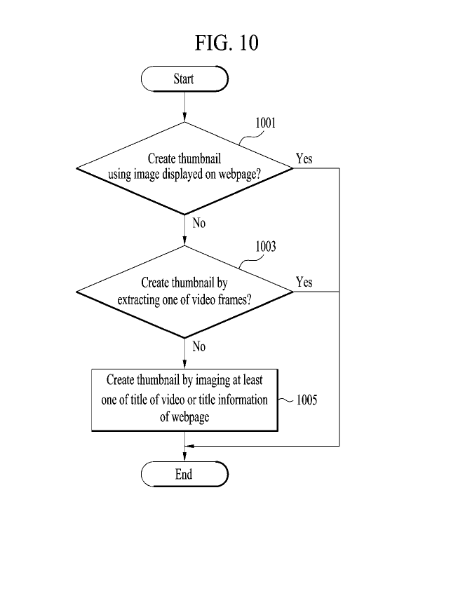

FIG. 6 is a diagram for one example to describe an execution file 600 structurally. The execution file 600 can be mainly configured with 3 kinds of regions. And, the region 620 for storing the address information of the video extracted in the step S503 corresponds to an essential configuration. In case that the execution file 600 is displayed on a video list, a thumbnail image file for identifying the video of the execution file from other video files is saved in the region 610. The thumbnail image file and a process for creating a thumbnail image shall be described with reference to FIG. 7 and FIG. 10 later, respectively.

The address information 411 of the webpage 410 is saved in the region 630. The address information 411 of the webpage 410 may be a URL address information of the webpage 410. After the controller 180 has accessed the webpage 410 through a web browser, as the video is included in the webpage 410, if a step of extracting the execution file proceeds, the controller 180 can control a step of extracting the address information of the webpage 410 to be performed. In particular, if the step of extracting the address information of the video is not performed on the video included in the webpage 410, the controller 180 can control the step of extracting the address information of the webpage 410 not to proceed as well.

The regions 610 and 620 may not correspond to the configurations essential to the creation of the execution file. In particular, although the thumbnail image and the webpage address are not obtained, the controller 180 can control the execution file to be created.

If the execution file is created, the execution file may have a file name 640 constructed with a file title and an extension name. According to the example shown in FIG. 6, the file title of the execution file is ‘Content title’ and the extension name is ‘.xxx’.

Referring now to FIG. 5, if the controller 180 detects an execution command for the created execution file, the controller 180 can control the video for the execution file to be executed. In particular, if the execution file is created, the controller 180 can treat the execution file in the same manner for other videos. Hence, the controller 180 can control the execution file to be displayed on the video list in response to a user input. In particular, if a user applies an input for accessing the video list, the controller 180 can control the created execution file to be displayed on the video list together with the other existing videos. In doing so, as mentioned in the foregoing description with reference to FIG. 6, if the thumbnail image file for the video is saved in the region 610, the execution file can be displayed as a thumbnail image on the video list.

If the execution file is selected from the video list by a user input, the controller 180 can recognize the selection as an execution command for the execution file. Hence, the controller 180 can control the video of the execution file to be played and displayed on the touchscreen 151.

In doing so, as mentioned in the foregoing description with reference to FIG. 6, the controller 180 can differentiate a video play system depending on a format of the address information saved in the region 620. For instance, if the address information of the video includes an information of URL format, the controller 180 accesses the corresponding address information and is then able to control the video to be played through a web browser. For another instance, if the address information of the video include an information of Java script command format, the controller 180 downloads video data from a web by streaming using a program for Java execution and is then able to control the video to be played using a video play program of the mobile terminal 100.

FIG. 7 is a diagram for one example to describe a creation interface of an execution file according to an embodiment of the present disclosure.

In FIG. 7, in order to describe the interface, assume a case that a webpage is displayed under the control of the controller 180 like the step 501. And, assume that a video is included in the webpage.

Referring to FIG. 7 (a), the controller 180 can detect that a video 413 is included in a webpage 410. In this case, the controller 180 can control an object 720, which is provided for a bookmark list registration for the corresponding webpage 410, and an object 710, which is provided for an execution file creation for the video 413 on the webpage 410, to be displayed on the webpage 410.

In particular, in order to facilitate an access to a video on a corresponding webpage, a user can save the corresponding webpage in a bookmark list and is able to directly access the video by creating an execution file for the video without performing a separate web browser execution process.

If a user inputs a touch gesture to the object 710 for the execution file creation, the controller 180 recognizes the inputted touch gesture as a command for creating an execution file for the video and then performs a video address information extraction operation for the execution file creation. If the extraction of the video address information is completed, the controller 180 saves the address information on the video in the region 620 of the execution file 600 shown in FIG. 6 and is able to control an execution file to be created. In doing so, the controller 180 can perform an address information extraction operation for the webpage in addition. If the address information of the webpage is extracted, the controller 180 can control the extracted webpage information to be saved in the region 630. Moreover, the controller 180 can additionally perform a thumbnail image creation operation for the video as well. Yet, the webpage address information extraction process and the thumbnail image creation process can be skipped except the video address information extraction operation that is an essential process.

Whether to perform the processes other than the essential process can be determined by a user or manufacturer's setup.

Referring to FIG. 7 (b), if the creation of the execution file is completed, the controller 180 can display a separate popup window 730. A user can set a file title and storage route of the created execution file through the separate popup window 730. The file title determined through the popup window 730 by the user was described as one example of the former file title on the file name 640 shown in FIG. 6.

According to the description with reference to FIG. 7 (b), after the creation of the execution file has been completed, the popup window 730 is displayed under the control of the controller 180. Yet, it is not necessary for the popup window 730 to be displayed after the completion of the execution file creation. Instead, the controller 180 may control the popup window 730 to be displayed if the user input to the object 710 is detected in FIG. 7 (a).

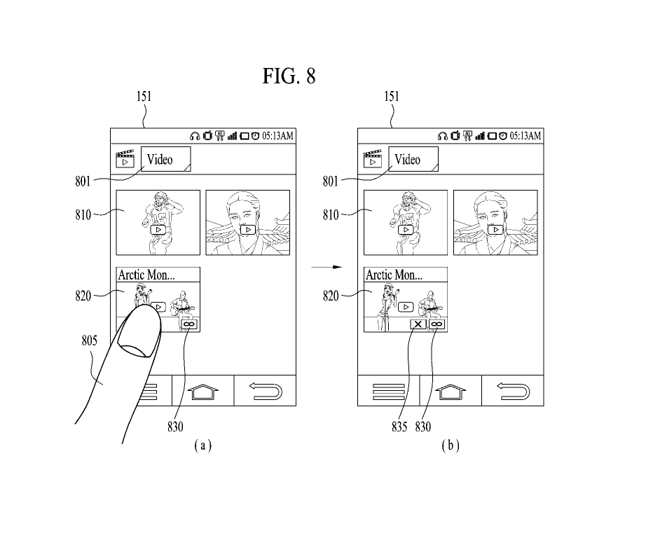

FIG. 8 is a diagram for one example to describe a video list according to an embodiment of the present disclosure.

Referring to FIG. 8 (a), if a user applies an input for displaying a video list, the controller 180 can control a video list 801 to be displayed. An execution file 820 created by the method described with reference to FIG. 7 is displayed on the video list 801 together with an existing video 810. In particular, FIG. 8 shows one example that the created execution file is displayed as a thumbnail image format 820.

An icon 830 for identifying that the execution file was created on a webpage is displayed on a bottom end of the thumbnail image 820 for the execution file [FIG. 8 (a)]. The controller 180 creates the execution file of the video on the webpage and is able to control an identification mark for distinguishing the created execution file from other video files to be displayed. The icon 830 is exemplarily provided. And, the controller 180 can control an icon differing from the icon 830 shown in FIG. 8 to be displayed in accordance with a selection made by a user or manufacturer. For instance, a user can set an icon of a desired type to be displayed at a desired location in a thumbnail image.

FIG. 8 (b) is a diagram for one example to describe a case that a created execution file on the video list 810 is not executable. As mentioned in the foregoing description, although the execution file 600 is saved in the mobile terminal 100, the execution file 600 is not an externally downloaded file or a file obtained from a photographing by a user. In particular, the execution file is a file for accessing a webpage in accordance with an address information format of a video, streaming down a video data from the webpage, and then playing the video data. Hence, if the video data is deleted from the corresponding webpage or the address information is changed, it may happen that the controller 180 is unable to play the video.

In this case, the controller 180 can control an icon, which is provided to inform a user that the corresponding video is not playable, to be displayed on the execution file. For instance, referring to FIG. 8 (b), the controller 180 can control an icon 835, which is provided to indicate whether the video is playable, to be displayed on a prescribed region of the execution file displayed as the thumbnail image.

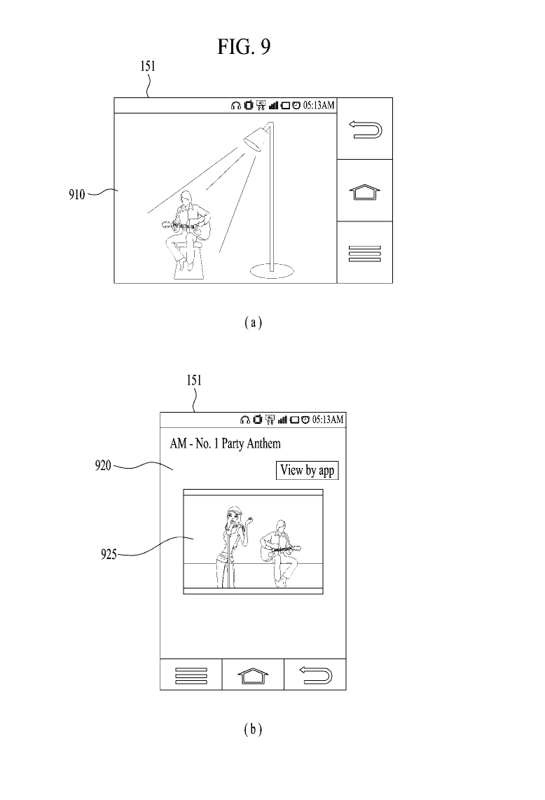

FIG. 9 is a diagram for one example to describe an execution scene of an execution file according to an embodiment of the present disclosure. First of all, if a user applies the touch gesture 805 to the thumbnail image 820 on the video list shown in FIG. 8 (a), the controller 180 can control the execution file to be executed.

Referring to FIG. 5 and FIG. 9, in response to a user's input, the controller 180 can control the video of the execution file to be played and displayed on the touchscreen 151 [S509]. In doing so, referring to FIG. 9 (a), the controller 180 can control the video of the execution file to be played and displayed on the touchscreen 151. A play screen of the video 910 shown in FIG. 9 (a) is identical to a screen displayed when the controller 180 plays an existing video. In particular, no matter what the existing video or the created execution file is played under the control of the controller 180, a user can have the same user experience (UX). Moreover, as mentioned in the foregoing description with reference to FIG. 6, no matter what the address information of the video follows URL format or Java script command format, as shown in FIG. 9 (a), the controller 180 can control the play screen of the same format to be displayed.

Referring to FIG. 9 (b), a video 925 is currently played in a manner of being posted on a webpage 920. In case that the format of an address information of the video extracted from the webpage 920 does not support a full screen play, the controller 180 can control a play screen shown in FIG. 9 (b) to be displayed. Even if there is a setting established by a user of the mobile terminal 100 or some restrictions put by a manufacturer, the controller 180 can control the play screen, as shown in FIG. 9 (b), to be displayed.

Meanwhile, FIG. 9 (a) may be assumed as showing a screen for playing a video of HD (high definition), while FIG. 9 (b) may be assumed as showing a screen for playing a video of LD (low definition).

Particularly, in case of selecting high definition or low definition in play a video on a webpage, when the controller executes an execution file in accordance with a user setting, referring to FIG. 9 (b), the controller 180 can control a video of low definition to be displayed only. The reason for this is that a user may be burdened with playing HD video of mass storage, as shown in FIG. 9 (a), depending on a communication service in which the mobile terminal 100 is subscribed.

Thus, since an execution file just plays a role in downloading packets of video data by streaming and playing the downloaded packets, each time the execution file is executed, the data communication use traffic of the mobile terminal 100 is unable to avoid increasing. In this case, a user can set the execution file to be executed in a specific communication environment only as an execution condition of the execution file.

For instance, a user can control an execution file to be executed in Wi-Fi communication environment or free-of-charge internet environment only. Moreover, only if a cumulative data use size of the mobile terminal 100 is equal to or lower than a predetermined level, the controller 180 can control a video to be played by having the wireless communication unit 110 perform a data communication. Alternatively, only if a size of a video is equal to or smaller than a predetermined size, the controller 180 can control an execution file to be executed.

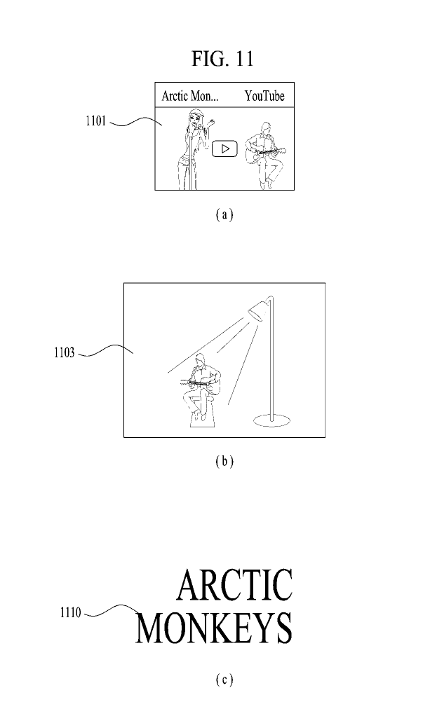

FIG. 10 us a flowchart to describe a process for creating a thumbnail image according to an embodiment of the present disclosure. And, FIG. 11 is a diagram for one example to describe a thumbnail image according to an embodiment of the present disclosure.

First of all, assume that a user sets the controller 180 to perform a thumbnail creating process after the former step S505 described with reference to FIG. 5.

Referring to FIG. 10 and FIG. 11, the controller 180 extracts an address information of a video and is then able to save the extracted address information in the region 620 of the execution file 600 described with reference to FIG. 6. Simultaneously, the controller 180 can control a thumbnail image to be created using an image displayed on a webpage [S1001].

For instance, referring to FIG. 11 (a), the controller 180 can extract an image such as a content of the video 413 displayed on the webpage 410 shown in FIG. 4 (a). If the image of the video displayed on the webpage is extracted, the controller 180 saves the image in the region 610 of the execution file 600 and is able to use it as a thumbnail image 1101 of the execution file. In this case, the controller 180 can control the execution file to be displayed as the thumbnail image 1101 on a video list.

If the thumbnail image 1101 is not extracted, the controller 180 can control a thumbnail image to be created by extracting one of video frames of the execution file [S1003]. For instance, referring to FIG. 11 (b), the controller 180 extracts a prescribed frame from the video play screen 910 shown in FIG. 9 (a) and is then able to image the extracted prescribed frame. In doing so, the controller 180 executes the execution file and is then able to extract a prescribed frame in the course of downloading video data by streaming. The controller 180 is able to save an image 1103 obtained from imaging the extracted prescribed frame in the region 610 of the execution file 600. Moreover, the controller 180 can control the execution file to be displayed as the thumbnail image 1103 on the video list.

If it is not possible to create the thumbnail images 1101 and 1103, the controller 180 can create a thumbnail image by imaging at least one of a title of a webpage or a title of a video [S1105]. In particular, for instance, the controller 180 controls the wireless communication unit 110 to access the webpage 410 shown in FIG. 4 (a) and is then able to obtain a title information of the webpage 410 from the webpage 410. In doing so, if the obtained title information is a text information, the controller 180 can create a thumbnail image by imaging the text information. If an image is included in the title information, the controller 180 can use the included image as a thumbnail image.

The controller 180 can obtain a title information of a video included in the webpage 410. If the title information of the video is a text information, the controller 180 can create a thumbnail image by imaging the text information.

FIG. 11 (c) shows one example of a thumbnail image created from imaging a text information by the controller 180.

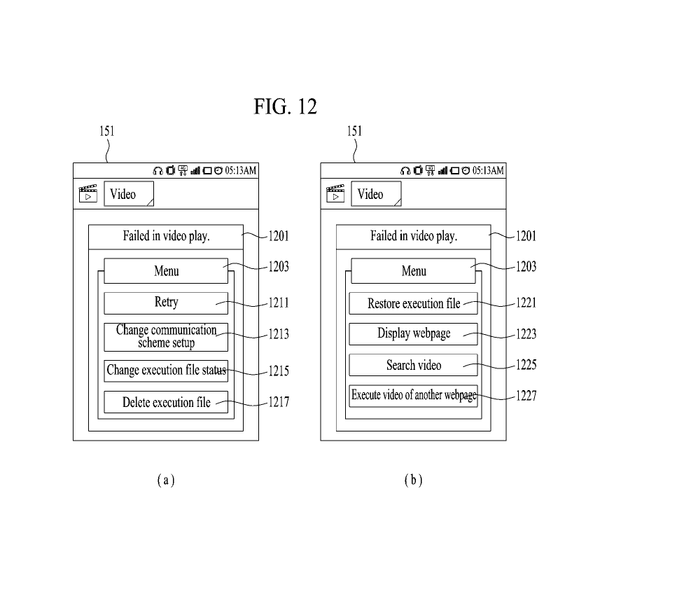

FIG. 12 is a diagram for one example to describe an operation of a mobile terminal 100 in case of failure in playing a video according to an embodiment of the present disclosure. According to a present embodiment, assume a case that the controller 180 is unable to play a video of an execution file despite the user's touch gesture shown in FIG. 8 (a). As mentioned in the foregoing description, such a case may correspond to one of a case that a webpage or a video in the webpage is deleted, a case that a video address information is changed, and a case that an address to a video address information is restricted in accordance with a poster's setting.

Referring now to FIG. 5, if the video is not executed in response to the user's execution command in the step S507, the controller 180 can display a menu window and perform a corresponding function in response to a user input [S511].

In case of the failure in playing a video, FIG. 12 (a) and FIG. 12 (b) show examples of operations, which can be performed by the mobile terminal 100 after the video play failure, as menus selectable from a separate popup window.

The menus respectively shown in FIG. 12 (a) and FIG. 12 (b) are provided for clarity of the following description. Optionally, the controller 180 can control the menus shown in FIG. 12 (a) and FIG. 12 (b) to be included in a single popup window. Moreover, other menus can be added to the menu(s) and a specific menu can be deleted from the corresponding menu. The number and types of items included in the menu(s) and the like can be determined by user's settings or manufacturer's settings.

Referring to FIG. 12 (a), the controller 180 can control a popup menu 1201, which includes a video play failure message, to be displayed. In the popup window 1201, a menu list 1203 for selecting a subsequent operation of the mobile terminal 100 can be included.

If ‘Retry’ 1211 is selected from the menu items, the controller 180 retries a video play of the execution file. For instance, the controller 180 accesses an address information of a video included in the corresponding execution file and is then able to try a play of the video. If the mobile terminal 100 enters a communication-available area from a communication-unavailable area, the controller 180 can control the video to be played. In doing so, a count and period of accessing the address information of the execution file can be determined by user's settings or manufacturer's settings. Despite retrying to play the video, if the controller 180 fails in playing the video again, the controller 180 can control the popup window shown in FIG. 12 (a) to be displayed again.

If ‘Change communication scheme setup’ 1213 is selected from the menu items, the controller 180 can output an interface for selecting a communication scheme of the wireless communication unit 110. Through the interface, a user can determine a free internet (e.g., Wi-Fi) or a pay internet (e.g., LTE, WCDMA). If the execution file is set in advance to be playable in a free internet communication environment only but the mobile terminal 100 is currently located in an environment available for a pay internet communication only, a user can watch the video by switching the communication scheme to the pay internet communication.

If ‘Change execution file status’ 1215 is selected, as mentioned in the foregoing description with reference to FIG. 8 (b), the controller 180 can control the icon 835, which means that the play is not possible, to be displayed on the thumbnail 820 of the execution file on the video list 801. The ‘Change execution file status’ can be automatically executed by the controller 180 even if there is no user input.

If ‘Delete execution file’ 1217 is selected from the menu items, the controller 180 can delete the execution file of the video from the video list 801 shown in FIG. 8 (b).

Referring to FIG. 12 (b), like the example shown in FIG. 12 (a), the controller 180 can control a popup menu 1201, which includes a video play failure message, to be displayed. In the popup window 1201, a menu list for selecting a subsequent operation of the mobile terminal 100 can be included.

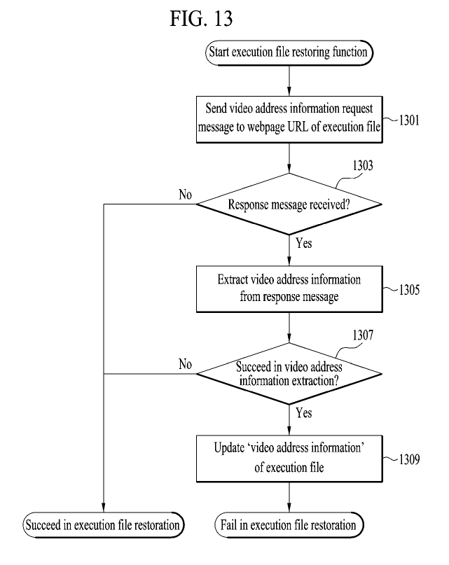

If ‘Restore execution file’ 1221 is selected from the menu items, the controller 180 performs a restoration operation of the execution file. This shall be described in detail with reference to FIG. 13 later.

If ‘Display webpage’ 1223 is selected from the menu items, the controller 180 can control a webpage including a video of an execution file to be displayed. In particular, the controller 180 can control the webpage 410 shown in FIG. 7 (a) or FIG. 7 (b) to be displayed. In this case, if a user desires to watch the video, the video play can be tried through the webpage.

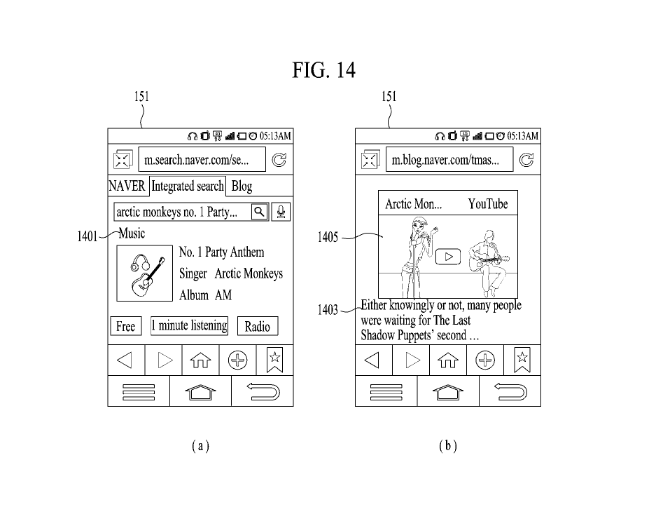

A case of selecting ‘Search videos’ 1225 from the menu items and a case of selecting ‘Execute video of another webpage’ 1227 from the menu items are described with reference to FIG. 14 as follows.

Referring to FIG. 14 (a), if ‘Search videos’ 1225 is selected from the menu items, the controller 180 can control a search execution screen 1401 of a web browser for the video to be displayed. In particular, the controller 180 can control the video search to be performed through the web browser using all informations in the video address information region 620, the thumbnail image region 610 and the webpage url region 630 of the execution file 600 shown in FIG. 6. The controller 180 can search the webpage including the same image as the thumbnail image and is able to use a video title of the thumbnail image as a search word.

Referring to FIG. 14 (b), if ‘Execute video of another webpage’ 1227 is selected from the menu items, the controller 180 can control a different webpage 1403 having the same video address information to be displayed. In particular, the controller 180 can control a webpage, which differs in url address of webpage despite that the video address information is identical to that saved in the execution file, to be searched. When a specific webpage including a video corresponding to the execution file is deleted, if the item 1227 is selected, the controller 180 accesses the different webpage 1403 including the video and then enables the video to be watched. And, a user can newly create an execution file by the process described with reference to FIG. 5.

Moreover, a user can save a preliminary address information in each of the region 620 for storing a video address information of an execution file and the region 630 for storing a webpage address information in advance.

In particular, in accordance with user settings, the controller 180 can save a different address information on a same video and a different webpage address information including the same video in the region 620 and the region 630 of the execution file, respectively. In this case, if the controller 180 tries an access to the address information of a video saved on an initial creation of the execution file or a webpage and then fails in playing the video, the controller 180 can control the video to be played using the preliminary address information. Although FIG. 13 (b) shows the case of displaying the webpage 1403 only, the controller 180 can control an execution screen, on which the video 1405 is directly played, to be displayed in accordance with user settings.

FIG. 13 is a diagram for one example to describe a process for restoring an execution file according to an embodiment of the present disclosure. A case of selecting ‘Restore execution file’ 1221 from the menu items shown in FIG. 12 (b) is described as follows.

Referring to FIG. 13, first of all, as the ‘Restore execution file’ is selected, the controller 180 can send a video address information request message to the url of a webpage including a video [S1301]. The controller 180 determines whether a response message is received from the webpage. If the response message is not received, an execution file restoring procedure is ended. For instance, this case may correspond to a case that an internet communication of the mobile terminal 100 is not available.

If the response message is received from the webpage, the controller 180 can extract an address information of the video from the response message again [S1305]. If the extraction of the video address information is successfully completed [S1307], the controller 180 can update the execution file by saving the extracted new information in the region 620 described with reference to FIG. 6 [S1309]. For instance, in case that a video poster changes a video address on the corresponding webpage only, it is able to update the execution file using the new address information of the video. In this case, it is advantageous in that the informations in the regions 610 and 630 of the execution file 600 can be used as they are.

On the contrary, if the controller 180 fails in the video address information extraction, the execution file restoring procedure is ended.

According to the example of the above embodiment, a content played by execution of an execution file is a video. Yet, if a user directly executes a content posted on a webpage instead of saving it in the mobile terminal 100, the above embodiment is applicable irrespective of a type of the content. In particular, an execution file of the present disclosure can be created to appreciate an image or music on a webpage.

Accordingly, embodiments of the present disclosure provide various effects and/or features.

First of all, the present disclosure can execute a web content displayed on a webpage without being saved in a mobile terminal in the same manner of executing a content saved in the mobile terminal.

Therefore, a mobile terminal according to the present disclosure can provide a more intuitive and simpler user experience in appreciating contents.

Secondly, a mobile terminal according to the present disclosure can directly create an execution file capable of executing a web content by accessing a webpage, on which the web content is displayed, instead of directly downloading the web content on the webpage.

It will be appreciated by those skilled in the art that the present disclosure can be specified into other form(s) without departing from the spirit or scope of the inventions.

In addition, the above-described methods can be implemented in a program recorded medium as processor-readable codes. The processor-readable media may include all kinds of recording devices in which data readable by a processor are stored. The processor-readable media may include ROM, RAM, CD-ROM, magnetic tapes, floppy discs, optical data storage devices, and the like for example and also include carrier-wave type implementations (e.g., transmission via Internet).

It will be appreciated by those skilled in the art that various modifications and variations can be made in the present disclosure without departing from the spirit or scope of the inventions. Thus, it is intended that the present disclosure covers the modifications and variations of this invention provided they come within the scope of the appended claims and their equivalents.

What is claimed is:

1. A mobile terminal comprising:
a wireless communication unit configured to access a webpage including a video;
a touchscreen configured to display the webpage; and
a controller configured to extract address information of the video from the webpage, create an execution file for the video to which the extracted address information is linked, and if an execution command for the execution file is inputted, control the video indicated by the address information to be played by streaming.

2. The mobile terminal of claim 1, wherein the controller is configured to create a thumbnail using an image for the video displayed on the webpage.

3. The mobile terminal of claim 1, wherein the controller is configured to create a thumbnail from a specific frame of the video.

4. The mobile terminal of claim 1, wherein the controller is configured to create a thumbnail by imaging at least one of a title of the video or title information of the webpage.

5. The mobile terminal of claim 1, wherein if the webpage including the video is displayed, the controller is configured to control an object, which is provided to receive a user input for determining whether to create the execution file, to be displayed on a prescribed region of the touchscreen and wherein if the user input to the object is detected, the controller is configured to create the execution file.

6. The mobile terminal of claim 1, wherein the address information of the video comprises either URL (Uniform Resource Locator) information of the video or a script command of the video.

7. The mobile terminal of claim 6, wherein if the address information of the video comprises the URL information, the controller is configured to control the video to be played following a setting in the web page.

8. The mobile terminal of claim 6, wherein if the address information of the video comprises the script command, the controller is configured to control the video to be played through a preset video play program.

9. The mobile terminal of claim 1, wherein the controller is configured to control the video to be played only if a communication scheme of the wireless communication unit corresponds to a preset communication scheme.

10. The mobile terminal of claim 1, wherein the execution file further comprises URL address information of the webpage.

11. The mobile terminal of claim 1, wherein if failing in playing the video, the controller is configured to control a selection window to be displayed to provide at least one selected from the group consisting of a tryout of a play of the video, a communication scheme setup change, a deletion of the execution file, or a status change indication of the execution file.

12. The mobile terminal of claim 1, wherein if failing in playing the video, the controller is configured to control a selection window to be displayed to provide at least one selected from the group consisting of a restoration of the execution file, a display of the webpage or a display for searching the video.

13. The mobile terminal of claim 12, wherein if the restoration of the execution file is selected through the selection window by a user, the controller is configured to re-extract the address information of the video displayed on the webpage and control the address information of the execution file to be updated into the re-extracted address information.

14. The mobile terminal of claim 13, wherein if failing in re-extracting the address information, the controller is configured to access the webpage using URL information of the webpage and control the webpage to be displayed.

15. The mobile terminal of claim 12, wherein the execution file further comprises title information of the video and wherein if the search screen display of the video is selected through the selection window by a user, the controller is configured to control a search for the video to be performed through a preset website using the title information.

16. The mobile terminal of claim 11, wherein if the state change indication of the execution file is selected through the selection window by a user, the controller is configured to control an execution impossible icon, indicating that the video is unable to play, to be displayed on a thumbnail image of the execution file.

17. A method of controlling a mobile terminal, comprising:
displaying a webpage including a video;
extracting address information of the video from the webpage;
creating an execution file for the video to which the extracted address information is linked; and
if an execution command for the execution file is inputted, playing the video indicated by the address information by streaming.

18. The method of claim 17, further comprising creating a thumbnail from a specific frame of the video.

19. The method of claim 17, further comprising if the video is not played in the playing step, searching for the video through a preset website using title information of the video.

20. The method of claim 17, further comprising:
if the video is not played in the playing step, re-extracting the address information of the video displayed on the webpage; and
updating the address information of the execution file into the re-extracted address information.
